(19) United States
(12) Patent Application Publication
(10) Pub. No.: US 2003/0028587 A1
(43) Pub. Date: Feb. 6, 2003

(54) System and method for accessing and storing data in a common network architecture

(76) Inventors: Michael C. Driscoll, Golden, CO (US); Justin T. Cragin, Bakersfield, CA (US); Steven A. Garcia, Bakersfield, CA (US); Michael L. Galloway, Bakersfield, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/854,053

(22) Filed: May 11, 2001

(51) Int. Cl. G06F 15/16

(52) U.S. Cl. 709/203; 709/206

(57) ABSTRACT

A system processes and stores electronic messages, voice, facsimile, and other data, in a common network architecture having high availability, high throughput, modularity, and linear scalability. The system has the ability to split processing among multiple server machines without having to split data. Electronic messages and other data are organized into folders for individual usernames. A folder daemon resident on a server utilizes a hashing algorithm to convert a username into a hash value corresponding to the folder under a directory of folders for the network's storage devices under which the electronic messages and other data are stored. Using the hashing algorithm, the folder daemon produces a statistically even distribution of folders across the network's storage devices. The folder daemon acts as a file system abstraction layer for the network. Unique numeric identification numbers are associated with the messages and other data in each folder.

### BACKGROUND OF THE INVENTION

The invention relates generally to systems and methods for processing, accessing and storing electronic messages and other data in a common network architecture.

Generally speaking, computer networks include a plurality of interconnected computing machines. Sharing computer resources in a network enables a requesting to computing machine (e.g., a client) to submit a request for an operation to be performed on another networked computer (e.g., a server). Servers, include for example, mail servers, database servers and file servers. Servers respond to requests by clients for the associated resources provided by the servers. The server processes the request and provides an appropriate response which informs the requesting client of the results. In a typical client/server based network, a number of diverse clients are communicatively coupled to one or more servers in order to facilitate the submission of a variety of requests to the servers.

Electronic messages, including “e-mail” as it is widely known, refers to messages that are sent from one computer user to another over interconnected computer networks. With the growth of network computing, e-mail is becoming a preferred mode of communication for a number of users or individuals. An e-mail message can contain, in addition to the required header information, a simple text message. An e-mail message can also contain attachments such as graphics, animation, and text having special encoding.

E-mail messages may be received and stored on network servers. An increasing number of e-mail messages are being stored for later retrieval when desired. Requests for electromc message retrieval can vary from, for example, a single message sent to a specific individual, or every stored message regarding a particular subject.

A daemon is a software program that executes in the background ready to perform an operation when required. Typical daemons include print spoolers and e-mail handlers, and may function on top of the server's operating system. The daemon may run on a server and handle client requests. Requests for retrieval of electronic messages by a client may entail a linear search throughout one or more global directories or tables of e-mail users on the network system, which can be burdensome on system resources and time-consuming. The growing use of e-mail and the increasing number of messages being saved, together with the accompanying demand for retrieving these saved electronic messages, has pointed to the need for an improved system for faster handling of electronic message storage and retrieval, and which is easily scalable in order to handle the ever increasing burdens placed on a computer network.

### SUMMARY OF THE INVENTION

A system for processing and storing message data for a username includes a folder daemon on a server. The folder daemon handles client requests for data, such as message data. The folder daemon includes a hashing algorithm to convert a username into a corresponding folder name under which the message data are stored. The hashing algorithm preferably spreads or distributes the folders as evenly as possible across the network's storage devices. Unique numeric identification numbers preferably are associated with the message data in each folder. Message data is to be understood to include, but not be limited to, voice mail (audio and/or video data), electronic messages (including e-mail text and/or embedded graphics), facsimile documents, and other data associated with a usemarne. The system may provide a common network architecture having scalability and improved storage and retrieval times for message data.

These and other aspects of the present invention will become apparent from the following more detailed description, when taken in conjunction with the accompanying exemplary drawings which illustrate, by way of example, embodiments of the invention. It is to be understood that the present invention is not limited by the embodiments described herein.

### DETAILED DESCRIPTION OF THE DRAWINGS

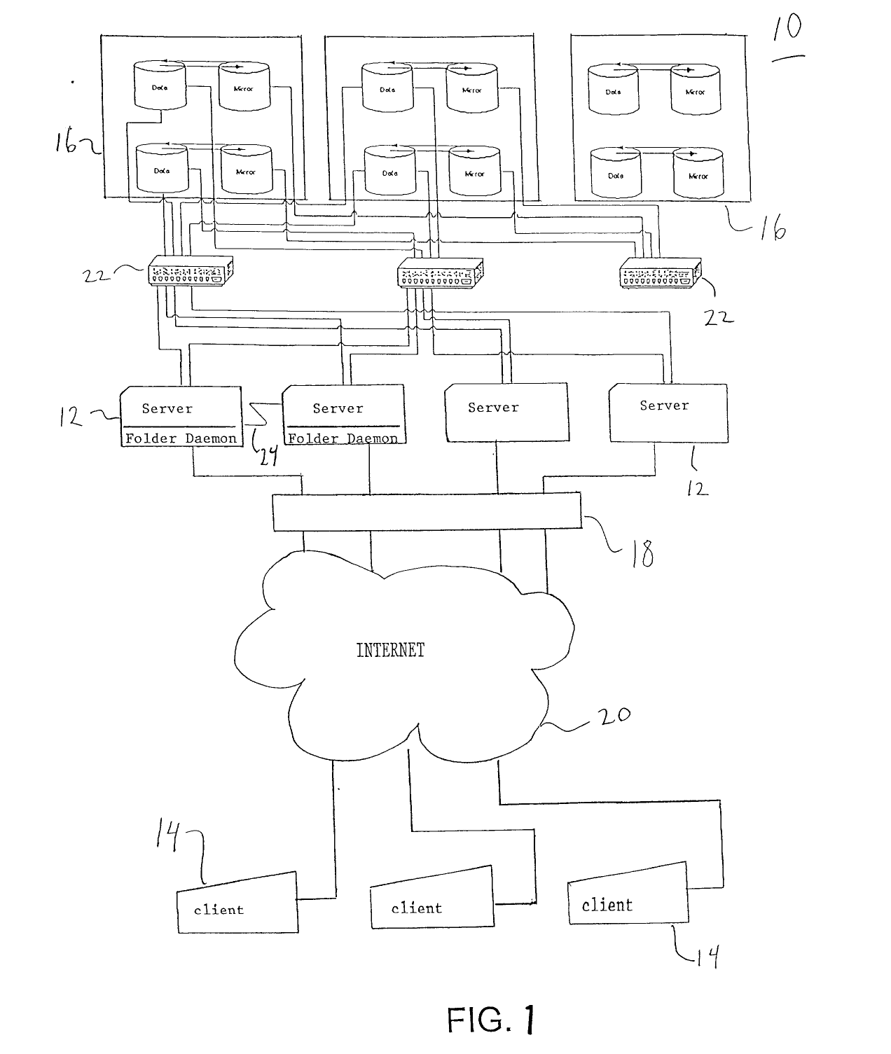

FIG. 1 is a block diagram of a network system incorporating an embodiment of the present invention;

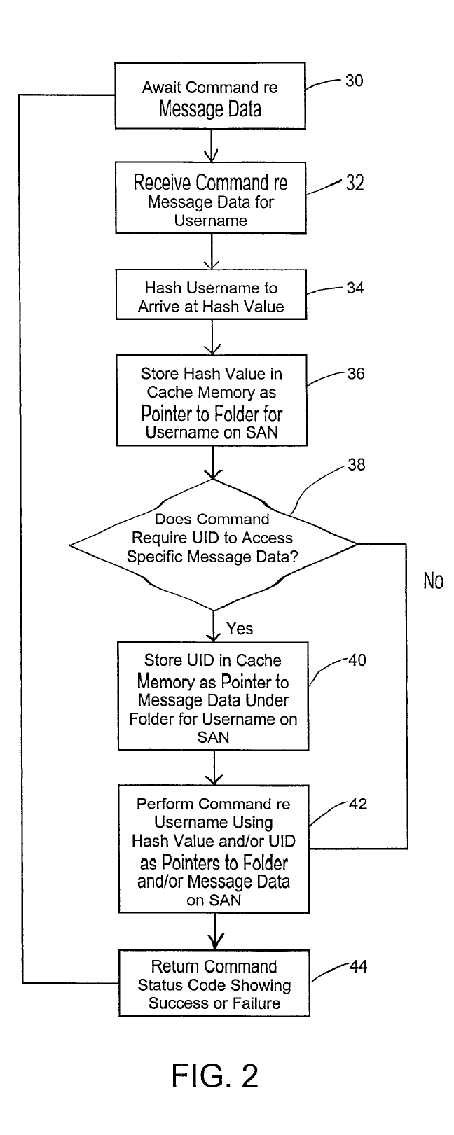

FIG. 2 is a flow chart illustrating the operation of the folder daemon for a network system incorporating an embodiment of the present invention;

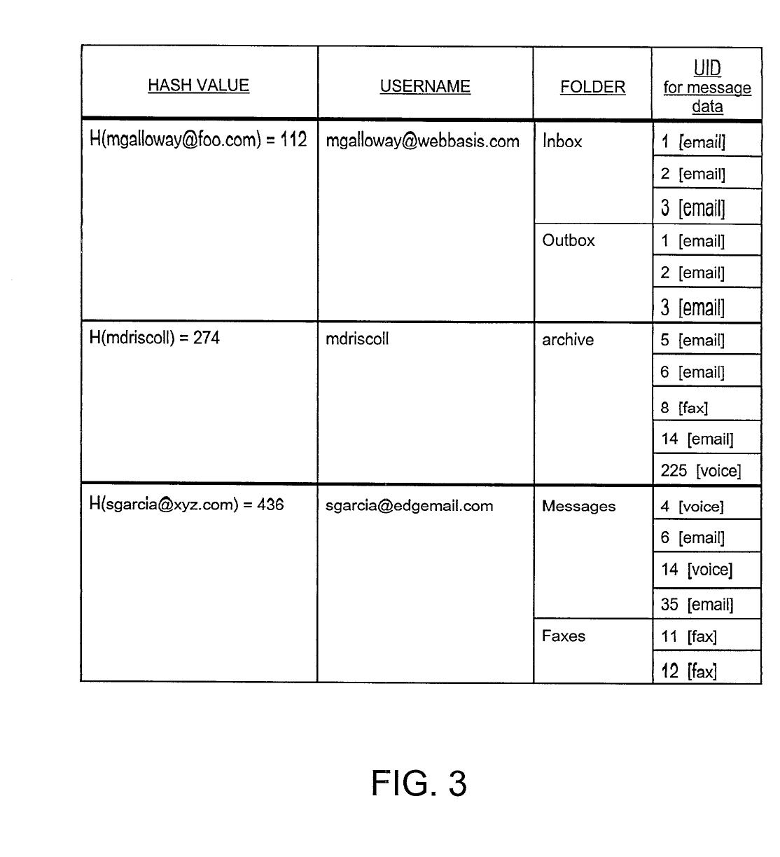

FIG. 3 is a block diagram of message data stored or cached in accordance with the operation of the folder daemon in a network system incorporating an embodiment of the present invention.

### DETAILED DESCRIPTION OF EMBODIMENTS OF THE INVENTION

Referring to the drawings, wherein like reference numerals denote like or corresponding parts throughout the drawing figures, and in particular to FIG. 1, a network system 10 is provided where a folder daemon is resident on at least one server 12 which is responsive to requests from a client 14 for storing and retrieving electronic messages from at least one network storage device 16. It should be appreciated that the embodiments of the system and method are illustrated and described herein by way of example only and not by way of limitation. For example, while the foregoing is described in terms of an internet network, it is to be understood that the present network system can also be used in an intranet network.

The servers 12 may include servers dedicated to a particular function or service, such as a mail server, database server, and file server. The network may utilize HP-UX, Solaris, Windows NT, or any other suitable operating system for the servers 12. The servers 12 preferably are connected to the internet 20 via a front-end processor 18 that transmits and receives messages, assembles and disassembles packets and detects and corrects errors. The front-end processor 18 interacts with the clients 14, and client requests are sent by the front-end processor 18 to the servers 12. Although it is not required that outside clients interact with the servers 12 only through the front-end processor 18, and the outside clients 14 may be directly connected to the servers 12 without a front-end processor 18, such a configuration would be less secure.

At least one server includes the folder daemon responsive to requests from the client 14 via the front-end processor 18 for storing and retrieving electronic messages from the network storage device 16. The details of the operation of the folder daemon will be discussed in further detail later.

The system preferably employs storage area networks (SANs) as the storage devices 16 for the network. SANs are back-end network connecting storage devices which utilize high-speed peripheral channels or I/O interconnections. Two known methods of implementing SANs are centralized and decentralized. A centralized SAN ties multiple hosts into a single storage system, which is a RAID device (i.e., “Redundant Arrays of Inexpensive Disks”) with large amounts of cache and redundant power supplies. A centralized storage topology is commonly employed to tie a server cluster together for failover. It is easier to keep data manageable and safe where data is stored in a single central implementation. In a decentralized topology, a SAN can connect multiple hosts with multiple storage systems. The folder daemon may be used with either storage topology.

The use of SANs can provide dynamic allocation of data storage, and the ability to split processing among multiple server machines without having to split data. SANs also enable storage consolidation in which a single pool of storage is shared by a relatively large number of servers. Storage consolidation permits redeployment of storage quickly. The use of SANs is known in the art and is not discussed in detail herein, except as may be expedient to describe the invention. This discussion is not intended to limit the present inventionto SANs, and other network storage devices such as network attached storage (NAS) may be employed.

The server or host is connected to the SAN via two fibre channel Host Bus Adapters (HBAs). Each HBA is connected to a separate fibre channel switch 22 which is connected to a port on a different controller for the SAN. Because each host has two complete and redundant paths to each element of storage, dynamic multipathing (DMP) can be utilized for failover events should any portion of the storage system fail. Additional backup servers (not shown), separately connected to a tape library, may also be included in the network.

The raw storage drives of the SAN are preferably arranged into array groups of four drives each, where each array group is striped using RAID5 (although RAID 0/1 may be used in the alternative). Preferably HP's XP512 array is utilized. In the event of a drive failure, “hot spare” drives (not shown) are preferably available in the array in order to provide for failover.

Application executables (or files containing a series of computer interpretable instructions that the computer can follow to perform a desired action) and data preferably are stored on the SAN in order to allow a selected software configuration to be replicated for a client in a short amount of time. This further provides the ability to swap servers without having to copy data or to restore from an archive by “pointing” the new server at the appropriate storage array in the SAN.

Each server or host preferably is allocated a set of storage logical units in increments of seven gigabytes (GP), but any suitably small increment or granularity may be used. Thus the available storage volumes can be of any suitably large size, preferably with a granularity of seven GB.

Servers having the same dedicated functions can access the same SAN or SANs for the necessary data to perform those functions. A cluster of computer servers provides fault tolerance and/or load balancing. If one system fails, one or more additional servers are still available. Having multiple servers perform the same function assists in load balancing the workload for handling such functions. Load balancing distributes the workload over multiple servers. Preferably, these servers are interconnected 24 to provide operational status or “heartbeat” information about each server's operation so that if one server fails, then the remaining operational servers will be able to implement a hot failover and quickly and efficiently handle the duties of the failed server. Because only operational status information is exchanged (which may include cached information such as an abstraction layer for file directory information), a high bandwidth I/O connection is not needed for this “heartbeat” function.

The servers or hosts can use the SAN as a data source and provide services such as the folder daemon services over the network. This can provide efficiencies in a high availability environment. Other servers or hosts can act as file servers which export their SAN connection over the network for the use of other servers. Such servers or hosts may not need to be set up for failover.

As illustrated by box 30 in the flow chart shown in FIG. 2, the folder daemon on the server awaits a command relating to message data. Receiving a command relating to message data for a username, the folder daemon operates in response to the request or command regarding message data, as illustrated at box 32 in FIG. 2. For example, the server may receive a request from a client (via the front-end processor) to store or retrieve message data from the network storage device such as a SAN. The folder daemon translates or hashes the username for the requested message data at box 34 in FIG. 2 to arrive at a fixed-length hash value for faster access and retrieval. The folder daemon acts as a file system abstraction layer for the network. The folder daemon preferably is implemented using standard UNIX directories.

The network preferably utilizes a network file system (NFS), a standard file sharing protocol in a UNIX network, which is the de facto UNIX standard, and which is widely known as a “distributed file system.” The server maintains a list of its directories that are available to clients. When a client mounts a directory on the server, that directory and its subdirectories become part of the client's directory hierarchy. Mounting causes a file on a server to be available for access locally by a client. The folder daemon may operate on top of the NFS or replace the NFS protocol for the message data.

The following is an example of the using of hashing in the present invention. A group of usernames (which may be used across different networks and domains) could be as follows:

mdriscoll

mgalloway@webbasis.com

sgarcia@edgemail.com

Each of these usernames would be the key for the folder in the directory for that username's data. A folder search mechanism would first have to start looking character-by-character across the name for matches until it found the match (or ruled the other entries out). For the unpredictable value length of a username, where each character had at least 26 possibilities and the computer would have to search through millions of characters, such a brute force technique is inefficient.

Using a hash algorithm (hash function) to hash each of the names, the folder daemon generates a hash value for a folder corresponding to each username. As an illustrative example (representing no particular hashing algorithm):

| | |
|---|---|
| 112 | mgalloway@webbasis.com |
| 274 | mdriscoll |
| 436 | sgarcia@edgemail.com |

The hash algorithm preferably converts the string of characters for the username into a fixed-length value or key that represents the original string. Hashing the username speeds up access to the folder containing the message data under that username. A search for a username would consist of computing the hash value of the requested username (using the same hash function used to store the username) and then comparing for a match using that value. As a general proposition, it would be much faster to find a match across a fixed number of digits (preferably three or four digits), each having at least 10 possibilities, than across an unpredictable value length where each character has at least 26 possibilities and the computer has to search through a large number of characters. It is to be understood that the present invention is not limited to the provided example above, and the hash value may have any suitable length.

The hashing algorithm preferably selects hash values which promote storage balancing between multiple SANs for the folders corresponding to the usernames. If folders were stored in an alphabetical sequence based upon the usernames, then there would be an uneven distribution of folders across the storage devices. For example, there may be a large number of usernames beginning with the letter “M” but relatively few beginning with the letter “Q.” As a result, certain storage devices would be heavily utilized and near capacity, while other server devices would be underutilized. Further, a more even or uniform storage distribution contributes to storage balancing and the linear scalability of the network. Modularity and scalability can be achieved by splitting the folder directory into blocks across multiple SANs for storage, where each block of the folder directory is similar in size.

Hash algorithms are known in the art and is not discussed in detail herein, except as may be expedient to describe the invention. The hash algorithm preferably should be relatively easy to compute, and produce a spread or distribution of hash values for the usernames so that the folders will be distributed relatively evenly (or as evenly as possible) across the network storage devices. The degree of uniformity or evenness of the storage distribution may be achieved according to the hash algorithm selected and utilized. The hash algorithm need not be collision free, and multiple usernames may produce the same hash value, but the hash algorithm should produce a statistically even distribution of usernames across the hash values.

An example of a suitable hash algorithm is as follows:

{

unsigned int hash = 0;
while (*username) {

hash *= 33;
hash += *username;
username++;

}
hash %= opts.hash;
return hash;

}

The “username” is a string like “mdriscoll.” The multiplier “33” is an arbitrary value that was selected, but any suitable value may be used. The “opts.hash” is the number of possible “slots” in which it is desired to hash the strings into. For example, an opts.hash of 512 will result in hash values of 0 through 511. Similarly, opts.hash values of 256 or 1024 may also be used. The opts.hash value may be arrived at based on the square root of the number of potential users.

In the hash algorithm, the hash is initialized to 0. The numeric value of the first character of the username string is added to the hash. The hash is multiplied by 33, whereupon the numeric value of the next character is added to the hash. This process continues for each succeeding character to the end of the string. After the last character is processed, the final value is modulo the parameter representing the range of the hash (the number of hash slots) desired.

A unique numeric identification number (UID) is generated for each message data, whether it is an e-mail message, voice mail, facsimile image (e.g., a tiff file), or other type of user-specific data. The UID may also identify the type for the message data, and may be set to “email,” “voice,” or “fax,” with “email” being the default designation. The UID may follow a simple numeric sequence function. The UlDs would increase linearly. In the alternative, another hashing algorithm may be used to hash the message data for each previously hashed folder name to arrive at the UID. UIDs are associated with the message data in each folder. The unique numeric identification numbers for each message may be considered unique within a folder such that the same numeric identification number will not refer to another message within that folder. Once a given UID is assigned, no other message data can receive the same UID in that same folder even if the original message data is deleted (unless the entire folder were deleted and then re-created).

As indicated at box 36 in FIG. 2, the servers on which the folder daemon resides can cache or store a hash directory or index of pointers to folders so that a temporary table of the folders of the hashed usernames is available. The temporary table cached on the folder daemon ervers may also include information regarding the message data stored in the folders. For example, the subject, data, “to” and “from” data fields for the message data stored in each folder can be stored or cached in the temporary table or index.

As indicated at box 38 in FIG. 2, the command will be executed unless the command requires a UID to access specific message data. In the latter instance, as indicated at box 40 in FIG. 2, the UIDs for specific message data stored under the folder may also be stored in the temporary table of directory information stored or cached on the servers on which the folder daemon resides. The UID may act as a pointer to message data under the folder for the username on the network storage devices. The temporary table cached on the server allows for faster access to folders and retrieval of message data and improved performance of commands or requests from the client.

As indicated at box 42 in FIG. 2, the server is able to perform the requested command relating to a username using a hash value (pointing to the folder for a username) or UID (pointing to a specific message under that folder) as pointers to folder and/or message data on the network storage devices. A cursor denoting the current highest UID number for a folder can also he stored or cached on the folder daemon servers.

As indicated at box 44 in FIG. 2, the server then returns a command status code showing success or failure of the requested operation, and the folder daemon awaits another command relating to message data for a username.

FIG. 3 is a block diagram illustrating a hierarchy for message data stored or cached in accordance with the operation of the folder daemon. The hash values (H(x)) represent the folders for the usernames, and the UIDs represent the message data for specific usernames. The message data includes email, voice, and fax data. It should be appreciated that this illustration herein as an embodiment is provided by way of example only and not by way of limitation.

The directory structure preferably follows the following format:

Hash_value/username/folder/UID

As previously discussed, each hash value may correspond to multiple usernames. In addition, each username may have multiple folder names, each of which having multiple UIDs for the message data. Furthermore, nested folders are possible so that each folder can have subfolders. The “@domain” portion of the “username” segment is not required, but is preferably supported by the folder daemon. For example, the first email message in the “Inbox” for mgalloway@webbasis.com would be: 112/mgalloway@webbasis.com/inbox/1.

The commands for the folder daemon preferably utilize the UID for specific messages within a folder, except for an LFOLDER command which may use “1” to refer to the message with the lowest UID value in the folder, “2” for the second lowest UID value, and so on. The LFOLDER command returns a listing of the wanted messages in the folder. For example, specifying the range “1 10” with the command LFOLDER would return the first ten messages in the desired folder.

The following is a protocol, including commands, for an embodiment of the folder daemon:

### FOLDER DAEMON COMMANDS

TOKENS

A note on input: all tokens con be input as bare tokens, ie. 123 or test/InBox. If any special characters are in the token (double-quote, space, tab, etc) then a quoted token should be used, ie. “123” or “test/Folder Name”. In a quoted token, the ‘\’ (backslash) and (double-quote) characters will be quoted with a ‘\’ (backslash).

FOLDERNAMES

Folder names are implemented as standard Unix directories, ie. case sensitive with a ‘/’ character as a delimiter.

The client should perform checks on the foldername provided to ensure that they are legal:

Leading characters ‘.’ (dot), ‘/’ (slash), and ‘ ’ (space) are not allowed.

The following characters are not allowed after a ‘/’ (slash):

‘/’ (slash), ‘.’ (dot), ‘ ’ (space), [0-9] (numerics).

Trailing spaces are not allowed.

Linefeeds and carriage returns are not allowed within the foldername.

The names ‘index’ and ‘cursor’ are reserved, and thus are not allowed as folder names or as parts of folder names.

USERNAMES

Usernames are case sensitive though usually case is smashed.

UIDS

Uids are numeric identification numbers associated with messages. All commands that deal with specific messages use these uids, with the exception of LFOLDER which user 1 to refer to the message with the lowest uid value in the folder, 2 for the second lowest, and so on.

Uids may be considered unique within a folder, and unique to a certain message, ie. the same uid will not refer to another message within that folder for the lifetime of the folder. This will cease to be true if the folder is deleted and re-created.

MESSAGES

The server assumes the messages given consist of a header followed by a blank line consisting of a CR or a CRLF followed by a body.

COMMAND CODES

Each command returns numeric codes to indicate command status, errors, and warnings. These codes consist of a three digit number followed by a space followed by a human readable message.

An example command code:

230 Ok.

When a command returns a three-digit number followed immediately by a dash followed immediately by a human-readable message, this should be considered an interim response on the part of the folder daemon. Any interim responses that occur will be followed immediately by a final response, which consists of the normal three-digit number followed immediately by a space followed immediately by a human-readable message.

An example of interim command codes:

230-Not done yet, but still ok

531-Nonfatal error

230-Almost done

230 Ok

The client may attempt to parse the interim return codes, but should always consider the final response as the true indicator of command status.

The codes currently used are as follows:

A 2xx code indicates successful command completion:

220 Folder daemon [Plan B] (v6.4)

Indicates a successful start of the daemon.

221 Closing connection

Indicates connection is being closed in response to client request or timeout.

230 Successful completion

Indicates that the command has completed without problems.

A 3xx code indicates partial completion; usually this indicates that more information is expected to be given by the client, or that the client is expected to supply data (the exact situation would be dependent on the command):

331 Accept data until “.”

Data is being supplied by the server, which will be terminated by a line consisting only of a period followed by a newline. Data given in this form has a period prepending any periods that occur in the beginning of a line; these added periods should be stripped. The period which marks the end of the data should not be considered to be part of the data.

For example, consider the following data:

foo

.bar

.

lastline

This would be transmitted by the server as follows:

331 Accept data until “.”

foo

..bar

..

lastline

.

The server will then return a code representing the success/failure of the operation.

333 Accept counted data

This response type is supposed to be sent by the MESSAGE8 command, but due to an error that command sends a 331. Other than the number being incorrect (331 vs. 333), the information below still holds true.

This will likely be fixed in the next major protocol revision.

The amount of data to be provided by the server will be specified by a number provided on the next line in curly braces ({}). This number will not account for bytes taken to print the braces, the number, nor the newline following the closing brace. In other words, this number begins counting from the beginning of the data to be sent. No data is sent after the specified number of bytes.

330 Proyide data, terminated by “.”

Data should be supplied by the client, terminated by a line consisting only of a period followed by a newline. This termination code will not be considered to be part of the data. Encoding of the data should be done in the same manner as data supplied by a 331. When the data has been terminated, the server will return another status code to indicate the completion status of the command (ie. during a STORE, a 330 will be given to indicate that the message should be supplied; after the message is terminated with a ‘.’ then a 230 would be returned if the message was successfully stored).

334 Provide counted data

This response type is currently only used by the STORE8 command.

The server will read data provided until the bytecount specified has been reached.

The server will then return a code representing the success/failure of the operation.

A 5xx code indicates an error during command execution. The second digit indicates the manner and/or severity of error:

50x: A syntax error or other similar client-based error.

53x: An error in client-supplied arguments, or an error in processing the client's request due to supplied arguments which may no longer by appropriate.

54x: A server-side system error (“hard” error).

Examples include:

501 Syntax error

530 User not found

Seen in commands which require username (SIZE, LIST). Attempting to perform command for user which does not exist.

530 Subfolder does not exist

(in cfolder) Attempting to create a folder when the folder next highest in the tree does not yet exist.

530 Folder not found

531 Message not found

532 Illegal user name

Seen in commands which require username (SIZE, LIST).

532 Illegal folder name

Folder name should not begin with any of the follow characters: ‘.’ (perid) ‘/’ (slash) ‘ ’ (space), or numerics (‘1’ through ‘9’ and ‘0’).

Folder name should not be an empty string.

Folder name should not end with a ‘/’ (slash), a ‘ ’ (space).

Folder name should not contain the ASCII codes CR or LF.

Folder name shall not be “index” or “cursor”, as these names are reserved by the system.

533 Folder exists

534 Must store messages in a subfolder

Messages cannot be stored under the user's name. Instead, they must be stored under a folder (ie. “username/folder” instead of “username”).

535 Header line not found

The header line requested was not found.

540 Unexpected fatal error processing request

The server has encountered a situation which is outside of the normal range of expected behavior; the system administrator should be notified in this situation.

541 Unable to lock folder

The locking process failed.

COMMANDS

STORE username/foldername

Store a single message in the folder provided. Server will return a ‘330’ code indicating that data should be provided, or an error code indicating error. Please see description of message 330 for a description of data encoding to be done.

Two ‘magic header lines’ will be used for index values if found:

‘Type’ may be set to ‘email’, ‘voice’, or ‘fax’, with ‘email’ being assumed if the header line is not found.

‘Priority’ may be set to ‘0’, ‘1’, or ‘2’, which stand for ‘normal’, ‘important’, or ‘ultra’, respectively. ‘0’ or ‘normal’ is assumed if the header line is not found.

>>>STORE test/InBox

<<<332 This message will be stored as UID:

<<<{123}

<<<330 Provide data

>>>From: foo

>>>>To: bar

>>>Subject: baz

>>>

>>>Message

>>>.

<<<230 Ok

STORE8 username/foldername bytecount

This command duplicates the STORE command with the difference that it uses the 334-style counted input method. bytecount is the number of bytes to be sent by the client and stored by the server.

The same ‘magic header lines’ are checked for, with the same behavior as in STORE.

>>>STORE test/InBox 40

<<<332 This message will be stored as UID:

<<<{123}

<<<334 Provide counted data

>>>From: foo

>>>To: bar

>>>Subject: baz

>>>

>>>Message

>>>

<<<230 Ok

FOLDER username/foldername

CFOLDER “username” will create the tree used by that particular user. This is accomplished in libemf with the create_folder( ) function, ie. create_folder(username, NULL, &error);

>>>CFOLDER test/InBox

<<<230 Ok

APPEND username/from username/to uid [uid uid ...]

Append (copy) a message or messages to another folder.

This command will return an interim response for each message append attempted, in the order specified by the command, followed by a final response. The client should not rely on interim responses being outputs however, as extreme error conditions will result in the operations never being attempted.

>>>APPEND test/InBox test/test 1 2 3

<<<230-Message [1] Ok

<<<531-Message [2] not found

<<<531-Message [3] not found

<<<230 Ok

DELETE username/foldername uid [uid uid ...]

Delete a message or messages from a folder.

This command will return an interim response for each message delete attempted, in the order specified by the command, followed by a final response. The client should not rely on interim responses being output, however, as extreme error conditions will result in the operations never being attempted.

>>>DELETE test/test 1 2 3

<<<531-Message [1] Ok

<<<531-Message [2] not found

<<<531-Message [3] not found

<<<230 Ok

ARANGE username/from username/to first_uid last_uid

Append (copy) a range of messages to another folder.

>>>ARANGE test/InBox test/test 20 25

<<<230-Message [23] Ok

<<<230-Message [24] Ok

<<<230-Message [25] Ok

<<<230 Ok

DRANGE username/foldername first_uid last_uid delete?

Delete a range of messages from a folder.

delete? represents a token with the value of either ‘0’ or ‘1’. A ‘1’ causes an empty folder to be deleted, a ‘0’ causes that empty folder to remain in place.

>>>DRANGE test/InBox 20 25 0

<<<230-Message [25] Ok

<<<220-Message [23] Ok

<<<230-Message [24] Ok

<<<230 Ok

BANISH username

Deletes all folders associated with the username.

>>>BANISH test

<<<230 Ok

READ username/foldername uid

Returns data needed by the function ‘function_read’, followed by the message header, a blank line, then the message body.

Also changes the read flag in the folder's index to mark the message as read.

This ‘extra’ data is of the form;

‘(’ to <SPACE> cc <SPACE> subject <SPACE> from <SPACE> date <SPACE> readflag <SPACE> type <SPACE> size ‘)’

to, cc, subject, from, and date are quoted strings, straight from the message header. Empty strings are used if the header does not exist in the message.

readflag is either ‘0’ or ‘1’.

size is an unsigned long.

type is one of ‘16’ (email), ‘17’ (voice), or ‘18’ (fax). This data is just taken from the message headers.

>>>READ test/InBox 33

<<<331 Accept data until “.”

<<<(“bar” “” “baz” “foo” “” 0 16 25)

<<<From: foo

<<<To: bar

<<<Subject: baz

<<<

<<<Message body goes here,

<<<.

REPLY username/foldername uid forward?

Returns data needed by the function ‘function_compose’, followed by optional forwarding information, followed by the message header, a blank line, then the message body.

Also changes the read flag in the folder's index to mark the message as read.

forward? represents a token with the value of either ‘0’ or ‘1’.

A ‘1’ causes the optional forwarding information to be sent, a

‘0’ causes this information to be skipped.

Reply data consists of:

‘(’ reply address <SPACE> cc address <SPACE> subject ‘)’ <NEWLINE>

Optional forward data consists of:

‘(’ date <SPACE> from <SPACE> to <SPACE> subject ‘)’ <NEWLINE>

All fields are quoted tokens.

“reply address” is a concatenation of the “From”, “Reply-To”, “Resent-From”, “Resent-Reply-To”, and “Sender” header lines.

>>>REPLY test/InBox 33 1

<<<331 Accept data until “.”

<<<(“foo” “” “baz”)

<<<(“” “foo” “bar” “baz”)

<<<From: foo

<<<To: bar

<<<Subject: baz

<<<

<<<Message body goes here.

<<<.

MESSAGE username/foldername uid header? body?

header? represents a token with the value of either ‘0’ or ‘1’. A ‘1’ causes the header to be returned to the client. A ‘0’ causes the header to be skipped.

body? represents a token with the value of either ‘0’ or ‘1’. A ‘1’ causes the body to be returned to the client. A ‘0’ causes the body to be skipped.

if both header? and body? are set, the header is sent, followed by a blank line, followed by the body.

>>>MESSAGE test/InBox 33 1 1

<<<321 Accept data until “.”

<<<From: foo

<<<To: bar

<<<Subject; baz

<<<

<<<Message body goes here.

<<<.

MESSAGE8 username/foldername uid header? body?

This command duplicates the MESSAGE command with the difference that it uses the 333-style counted response and is used for arbitrary binary data.

>>>MESSAGE8 test/InBox 33 1 1

<<<331 Accept counted data

<<<{61}

<<<From: foo

<<<To: bar

<<<Subject: baz

<<<

<<<Message body goes here.

LFOLDER username/foldername first last

Returns a listing of the wanted messages in the folder, to be used by the functions ‘function list’ and ‘function_main’. As stated above, first and last are not uids, instead they represent the specific range wanted of the messages in the folder, ie. “1 10” which would return the first 10 messages in the folder, after being sorted by uid.

Data returned: number of messages, highest message number in folder, number of unread messages, followed by directory data, followed by the message data requested.

Directory data consists of:

‘(’ ‘0’ <SPACE> dirname ‘)’

dirname is the name of a sub-directory, and is a quoted token.

Message data consists of:

‘(’ message uid <SPACE> subject <SPACE> date <SPACE> from <SPACE>

readflag <SPACE> body part count <SPACE> size <SPACE> type <SPACE>

priority ‘)’ <NEWLINE>

subject, date, and from are quoted tokens. The rest of the fields are integers.

‘readflag’ should be 0 or 1 for unread/read, respectively

‘type’ should be compared to the values in em_folderd/msg_types.h

‘priority’ will be 0, 1, or 2, for normal, important, or ultra, respectively.

>>>LFOLDER test/InBox 1 5

<<<331 Accept data until “.”

<<<(10)

<<<(33)

<<<(8) <<<(0 “foo”)

<<<(0 “bar”)

<<<(1 “Test Account <test@diva>” “Thu, Nov. 16, 2000 17:02:45 GMT” “Michael Driscoll <fenris@ulf.edgemail.com>” 1 0 34007 16 0)

<<<(18 “foo@bar.baz” “” “fenris@ulf.edgemail.com” 1 1 153 17 2)

<<<(26 “TNEF test” “Mon, Feb. 26, 2001 09:25:46-0800” “\”Pop Tester\“<brpop@webbasis.com>” 1 3 62734 16 0)

<<<(27 “” “” “” 0 1 0 160)

<<<(28 “” “” “” 0 1 22 16 0)

<<<.

LUID username/foldername

Returns a list of the message uids present in that folder.

>>>LUID test/InBox

<<<331 Accept data until “.”

<<<(1)

<<<(18)

<<<(26)

<<<(27)

<<<(28)

<<<(29)

<<<(30)

<<<(31)

><<(32)

<<<(33)

<<<.

HLINE username/foldername uid header

Returns the contents of the header-line requested.

>>>HLINE test/InBox 33 “From”

<<<331 Accept data until “.”

<<<(“foo@bar.baz”)

<<<.

LIST username

Returns a list of the folders owned by that user.

>>>LIST test

<<<331 Accept data until “.”.

<<<i

<<<InBox

<<<InBox/foo

<<<InBox/bar

<<<test

<<<Trash

<<<Sent

<<<a

<<<b

<<<fing

<<<fing/fing

<<<fing/fing/grob

<<<fing/fing/grob/a

<<<.

SIZE username

Returns the numker of bytes in use by that user.

>>>SIZE test

<<<331 Accept data until “.”

<<<(89717)

<<<.

VERSION

Return the Yersion number of the folder daemon.

>>>VERSION

<<<331—This is folder daemon [PlanB] (v6.4)

<<<331 Please accept this humble offering of data:

<<<(6.4)

<<<.

NEXT username/foldername uid

Returns the uid that follows the given uid in the given folder.

>>>NEXT test/InBox 1

<<<331 Accept data until “n.”

<<<(18)

<<<.

PREV username/foldername uid

Return the uid that precedes the given uid in the given folder.

>>>PREV test/InBox 33

<<<331 Accept data until “.”

<<<(32)

<<<.

READFLAG username/folder uid [newflag]

If newflag is not specified, returns the current read status of the given message (0 for unread, 1 for reacd). If newflag Is “1” or “9”, then the read status is set to the given status.

Note: In this example we not only set a new readflag (“0”, or unread) we are also returned the original readflag (“1”, or read).

>>>READFLAG test/InBox 33 0

<<<331 Accept data until “.”

<<<(1)

<<<.

COUNTS username/folder

Returns message counts for the folder.

The returned data are of the form;

‘(’ total unread <SPACE> email unread <SPACE> voice unread <SPACE> fax unread <SPACE> ‘)’ <NEWLINE>

‘(’ total messages <SPACE total email <SPACE> total voice <SPACE> total fax <SPACE> ‘)’ <NEWLINE>

>>>COUNTS test/InBox

<<<331 Unread (all email voice fax) then Total (all email voice fax)

<<<(9 9 0 0)

<<<(13 12 1 0)

<<<.

QUIT

Closes the connection.

>>>QUIT

<<<221 Closing connection

Connection closed by foreign host.

While illustrated and described herein in terms of its use in connection with the storage and retrieval of message data such as electronic messages, voice mail, and facsimile, it will be apparent to those skilled in the art that the network system and folder daemon can be used with other types of file data. The folder daemon may also be used on other network topographies known in the art. Other modifications and improvements may be made without departing from the seope of the invention.

1. A network system comprising:
at least one storage device, wherein the at least one storage device is capable of storing data, wherein the data is associated with a username;
at least one server connected to the at least one storage device so as to access the data on the at least one storage device;
a daemon on the at least one server for controlling storage distribution in the at least one storage device by applying a hashing algorithm to the username associated with the data.

2. The network system of claim 1, wherein the data includes e-mail messages.

3. The network system of claim 1, wherein the data includes audio data.

4. The network system of claim 1, wherein the daemon stores and accesses data on the at least one storage device based on the hashing algorithm, wherein the stored and accessed data is distributed on the at least one storage device in a substantially uniform manner.

5. The network system of claim 1, wherein the at least one storage device includes a first folder and a subfolder under the first folder, the daemon assigns a unique identification number to the data stored on the at least one storage device, the first folder corresponds to a hash value produced by the hashing algorithm, and the data is associated with the unique identification number in the subfolder.

6. The network system of claim 1, wherein the at least one server further includes a first server and a second server, wherein the first server is interconnected with the second server to provide respective operational information.

7. The network system of claim 1, wherein the at least one storage device includes the storage area network.

8. The network system of claim 7, wherein application executables are stored on the storage area network.

9. A network system comprising:
a first storage device and a second storage device, wherein the first and second storage devices are capable of storing data, wherein the data is associated with a username;
a first server and a second server, wherein the first server is connected to the first storage device and the second storage device, and the second server is connected to the first storage device and the second storage device, and the first server and the second server are both capable of accessing the data on the first storage device and the second storage device;
a daemon on the first server to control the storage distribution of the data in the first and second storage devices by applying a hashing algorithm to the username associated with the data.

10. The network system of claim 9, wherein the data includes e-mail messages.

11. The network system of claim 9, wherein the data includes audio data.

12. The network system of claim 9, wherein the daemon stores and accesses data on the first and second storage devices based on the hashing algorithm, wherein the stored and accessed data is distributed on the first and second storage devices in a substantially uniform manner.

13. The network system of claim 9, wherein the first storage device includes a first folder and a subfolder under the first folder, the daemon assigns a unique identification number to the data stored on the first storage device, the first folder corresponds to hash value produced by the hashing algorithm, and the data is associated with the unique identification number in the subfolder.

14. The network system of claim 9, wherein the first server is interconnected with the second server to provide respective operational information.

15. The network system of claim 9, wherein the first storage device includes a storage area network.

16. The network system of claim 15, wherein application executables are stored on the storage area network.

17. A network system comprising:
a storage device capable of storing data associated with a username, wherein the storage device includes a directory of folders having a first folder and a subfolder under the first folder, wherein the data is stored in the subfolder;
a server connected to the storage device so as to access the data on the storage device; wherein the server includes a daemon, the daemon applies a hashing algorithm to the username associated with the data to produce a hash value, the daemon assigns a unique identification number to the data stored on the storage device;
wherein the first folder corresponds to a hash value produced by the hashing algorithm, and the data is associated with the unique identification number in the subfolder.

18. The network system of claim 17, wherein the data includes e-mail messages.

19. The network system of claim 17, wherein the data includes audio data.

20. The network system of claim 17, wherein the daemon stores and accesses data on the storage device based on the hashing algorithm, wherein the stored and accessed data is distributed on the at least one storage device in a substantially uniform manner.

21. A computer network method comprising the steps of:
accepting a command function relating to data associated with a username;
performing a hashing function on the username to produce a hash value for the username;
accessing a folder on a network storage device based on the hash value, wherein the data is stored under the folder on the network storage device; and
performing the command function relating to the data in the folder.

22. The computer network method of claim 21, wherein a plurality of folders are stored on the network storage devices, and the hashing function produces a substantially even distribution of folders across the storage devices of the network.

23. The computer network method of claim 21, further comprising the step of caching the hash values produced by the step of performing the hashing function.

24. The computer network method of claim 23, wherein the step of caching creates an index of hash values.

25. The computer network method of claim 21, wherein the step of accessing further includes the step of associating a unique identification number with the data.
